(19) United States
(12) Patent Application Publication
(10) Pub. No.: US 2021/0201205 A1
(43) Pub. Date: Jul. 1, 2021

(54) METHOD AND SYSTEM FOR DETERMINING CORRECTNESS OF PREDICTIONS PERFORMED BY DEEP LEARNING MODEL

(71) Applicant: Wipro Limited, Bangalore (IN)

(72) Inventors: Arindam Chatterjee, Bangalore (IN); Manjunath Ramachandra lyer, Bangalore (IN); Vinutha Bangalore NARAYANAMURTHY, Bangalore (IN)

(21) Appl. No.: 16/793,173

(22) Filed: Feb. 18, 2020

(30) Foreign Application Priority Data
Dec. 26, 2019 (IN) 201941053960

(51) Int. Cl. G06N 20/10; G06N 3/08; G06N 3/04; G06F 17/16

(52) U.S. Cl. CPC G06N 20/10; G06F 17/16; G06N 3/04; G06N 3/08

(57) ABSTRACT

The disclosure relates to method and system for determining correctness of predictions performed by deep learning model. The method includes extracting a neuron activation pattern of a layer of the deep learning model with respect to the input data, and generating an activation vector based on the extracted neuron activation pattern. The method further includes determining the correctness of the prediction performed by the deep learning model with respect to the input data using a prediction validation model and based on the activation vector. The prediction validation model is a machine learning model that has been generated and trained using training activation vectors derived from correctly predicted test dataset and incorrectly predicted test dataset of the deep learning model. The method further includes providing the correctness of the prediction performed by the deep learning model with respect to the input data for subsequent rendering or subsequent processing.

### TECHNICAL FIELD

The present invention relates to deep learning models. More particularly, the present invention relates to a method and system that helps in determining the percentage correctness of results predicted by the deep learning model.

### BACKGROUND

In today's world, an increasing number of applications are utilizing Artificial Intelligence (AI) to extract useful information and to make predictions. Typically, AI includes machine learning (ML) models and deep learning models. ML models are statistical learning models where each instance in a dataset is described by a set of features or attributes. In contrast, deep learning models extract features or attributes from raw data. It should be noted that deep learning models perform the task by utilizing neural networks with many hidden layers, big data, and powerful computational resources.

Over past few years, deep learning models have gathered a lot of attention over the classical ML models as they deliver more accurate and effective results for a wide range of tasks having different levels of difficulties. Though, the deep learning models provide high-level of precise outcomes for complex tasks, but the main difficulty is to trust the predictions made by such models. This is especially true in the fields where the risk is not acceptable such as autonomous vehicles, medical diagnosis, stock markets, etc. The quotient of trust relies on explainability of the predictions (i.e., understanding the behavior of model) as well as accuracy of the predictions.

Various techniques have been developed that provides rational behind the predictions made by the deep learning models. Such techniques partially resolve the issue of the trust that can be placed upon these models, but they do not help in detecting an incorrect prediction provided by the deep learning model. In other words, existing techniques fail to provide information about the correctness/incorrectness of predictions made by the deep learning model.

### SUMMARY

In one embodiment, a method of determining a correctness of a prediction performed by a deep learning model with respect to input data is disclosed. In one example, the method may include extracting a neuron activation pattern of at least one layer of the deep learning model with respect to the input data. The method may further include generating an activation vector based on the neuron activation pattern of the at least one layer of the deep learning model. The method may further include determining the correctness of the prediction performed by the deep learning model with respect to the input data using a prediction validation model and based on the activation vector. It should be noted that the prediction validation model may be a machine learning model that has been generated and trained using a plurality of training activation vectors derived from correctly predicted test dataset and incorrectly predicted test dataset of the deep learning model. The method may further include providing the correctness of the prediction performed by the deep learning model with respect to the input data for at least one of subsequent rendering or subsequent processing.

In another embodiment, a system for determining a correctness of a prediction performed by a deep learning model with respect to input data is disclosed. In one example, the system may include a processor and a memory communicatively coupled to the processor. The memory may store processor-executable instructions, which, on execution, may cause the processor to extract a neuron activation pattern of at least one layer of the deep learning model with respect to the input data. The processor-executable instructions, on execution, may further cause the processor to generate an activation vector based on the neuron activation pattern of the at least one layer of the deep learning model. The processor-executable instructions, on execution, may further cause the processor to determine the correctness of the prediction performed by the deep learning model with respect to the input data using a prediction validation model and based on the activation vector. It should be noted that the prediction validation model may be a machine learning model that has been generated and trained using a plurality of training activation vectors derived from correctly predicted test dataset and incorrectly predicted test dataset of the deep learning model. The processor-executable instructions, on execution, may further cause the processor to provide the correctness of the prediction performed by the deep learning model with respect to the input data for at least one of subsequent rendering or subsequent processing.

In yet another embodiment, a non-transitory computer-readable medium storing computer-executable instructions for determining a correctness of a prediction performed by a deep learning model with respect to input data is disclosed. In one example, the stored instructions, when executed by a processor, may cause the processor to perform operations including extracting a neuron activation pattern of at least one layer of the deep learning model with respect to the input data. The operations may further include generating an activation vector based on the neuron activation pattern of the at least one layer of the deep learning model. The operations may further include determining the correctness of the prediction performed by the deep learning model with respect to the input data using a prediction validation model and based on the activation vector. It should be noted that the prediction validation model may be a machine learning model that has been generated and trained using a plurality of training activation vectors derived from correctly predicted test dataset and incorrectly predicted test dataset of the deep learning model. The operations may further include providing correctness of the prediction performed by the deep learning model with respect to the input data for at least one of subsequent rendering or subsequent processing.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. is a block diagram of an exemplary system for creating deep learning model and prediction validation model, in accordance with some embodiments of the present disclosure.

FIG. 2 is a block diagram of an exemplary system for determining correctness of predictions performed by the deep learning model, in accordance with some embodiments of the present disclosure.

FIG. 3 is a flow diagram of an exemplary process for determining correctness of predictions performed by deep learning model, in accordance with some embodiments of the present disclosure.

FIG. 4 is a flow diagram of a detailed exemplary process for determining correctness of predictions performed by deep learning model, in accordance with some embodiments of the present disclosure.

FIG. 5 is an illustration of a neural network based deep learning model with activation vectors in LSTM layer and dense layer, in accordance with some embodiments of the present disclosure.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

Referring now to FIG. 1, an exemplary system 100 for creating a deep learning model 105 and a prediction validation model 106 is illustrated, in accordance with some embodiments of the present disclosure. The deep learning model 105 is created for a particular application (e.g., sentiment analysis, image classification, etc.), while the prediction validation model 106 is created for estimating correctness of predictions made by the deep learning model 105. The system 100 includes a deep learning unit 102, a prediction validation device 107, and a data repository 108. The prediction validation device 107 further includes an activation pattern extraction unit 103 and a prediction validation unit 104. The data repository 108 stores, among other things, the deep learning model 105 and the prediction validation model 106 created by the system 100.

As will be described in greater detail below, the deep learning unit 102 creates the deep learning model 105 using annotated data 101. The annotated data 101 is obtained by the process of annotation (that is, labeling of data). The process of data annotation is executed by using various tools such as bounding, semantic segmentation, etc. The annotated or labeled data 101 may include, but may not be limited to text, audio, images, or video. The annotated data 101 is fed to the deep learning unit 102 for training and testing the deep learning model 105. As will be appreciated, the annotated data 101 may be separated into a training dataset and a test dataset.

The deep learning unit 102 receives the annotated data 101 for generating, training, and testing the deep learning model 105. Initially, the pre-processing of received annotated data 101 is performed by the deep learning unit 102 in order to eliminate the irregularities present within the annotated data 101. For example, for a sentiment analysis and classification application, the elimination of irregularities includes cleaning sentiment tagged sentences, removal of punctuations and irrelevant words, tokenizing the sentences, and so forth. Following the elimination of irregularities from the annotated data 101, the deep learning unit 102 generates and trains the deep learning model 105 to preform appropriate predictions using training dataset. For example, the deep learning model 105 may be trained to predict sentiments. The deep learning unit 102 further validates the trained deep learning model 105 using test dataset. The deep learning unit 102 uses at least one of a multilayer perceptron (MLP) model, a convolutional neural network (CNN) model, a recursive neural network (RNN) model, a recurrent neural network (RNN) model, or a long short-term memory (LSTM) model as the deep learning model.

As discussed earlier, one of the primary issues is to trust the predictions made by the deep learning model 105. The prediction validation device 107, therefore, creates the prediction validation model 106 for identifying incorrect predictions, in accordance with some embodiments of the present disclosure. In particular, the prediction validation model 106 identifies incorrect predictions by analyzing layer-wise neuron activation patterns inside the deep learning model 105. The activation pattern extraction unit 103, coupled to the deep learning unit 102, extracts layer-wise activation patterns of neurons from the deep learning model 105. The activation pattern extraction unit 103 extracts the correct/incorrect predictions performed by the deep learning unit 102 along with neuron activation patterns corresponding to the correct/incorrect predictions. A Layer-Wise Relevance Propagation (LRP) mechanism is used by the activation pattern extraction unit 103 for extracting the patterns of neuron activation. The extracted patterns, with respect to correct or incorrect predictions, are transmitted to the prediction validation unit 104 h an aim of generating the prediction validation model 106.

The prediction validation unit 104 receives the neuron activation patterns corresponding to correct prediction as well as incorrect prediction transmitted by the activation pattern extraction unit 103. The prediction validation unit 104 is interlinked between activation pattern extraction unit 103 and data repository 108 in order to receive the information from activation pattern extraction unit 103 and transmit the generated prediction validation model 106 to the data repository 108. The unit 104 employs the received layer-wise neuron activation patterns for the correct as well as incorrect predictions to generate a prediction validation model 106. The prediction validation unit 104 utilizes machine learning technology for generating the prediction validation model 106.

The data repository 108 is attached with the deep learning unit 103 and prediction validation unit 104. The data repository 108 is a storage that aggregates and manages the generated deep learning model 105 as well as prediction validation model 106 generated by deep learning unit 102 and prediction validation unit 104, respectively.

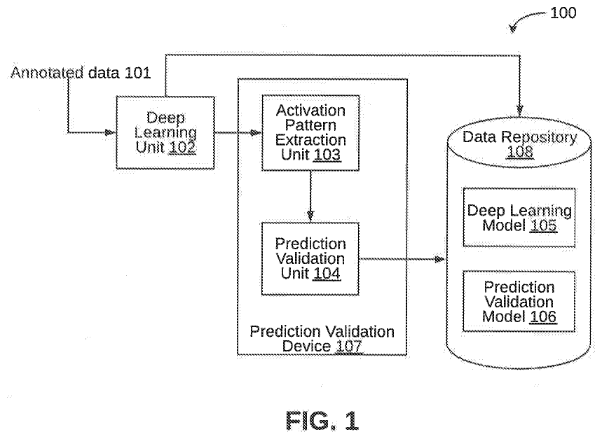

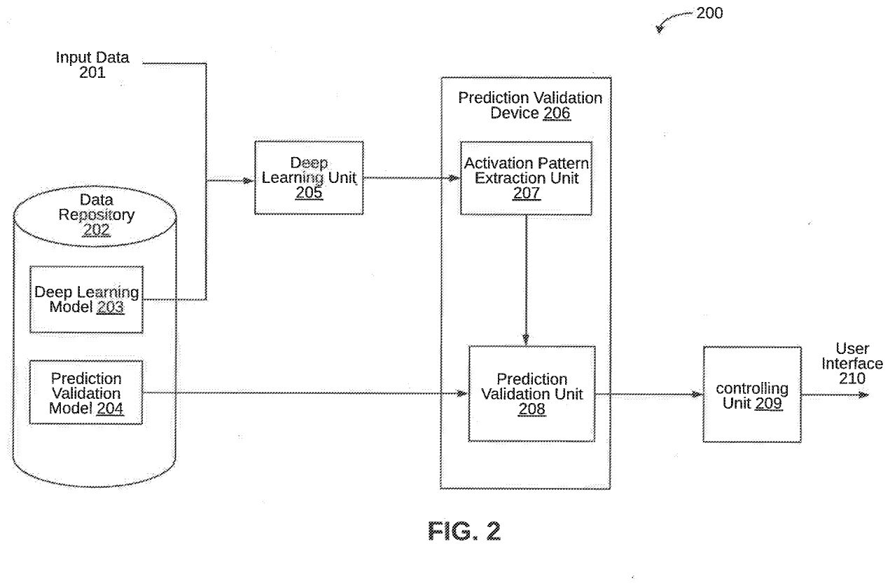

Referring now to FIG. 2, an exemplary system 200 for determining correctness of predictions performed by the deep learning model is illustrated, in accordance with some embodiments of the present disclosure. The system 200 comprises of a data repository 202 (analogous to the data repository 108) incorporating a deep learning model 203 (analogous to the deep learning model 105) and a prediction validation model 204 (analogous to the prediction validation model 106). The system 200 further includes a deep learning unit 205 (analogous to the deep learning unit 102), an activation pattern extraction unit 207 (analogous to the activation pattern extraction unit 103), a prediction validation unit 208 (analogous to the prediction validation unit 104), a controlling unit 209, and a user interface 210. The system 200 receives input data 201, which is a sequential data and available in the form of text, speech, raster image, etc. In particular, the input data 201 is injected to the deep learning unit 205 in order to perform the prediction on the input data 201.

The deep learning unit 205 retrieves the deep learning model 203 from the data repository 202 so as to perform the prediction on the input data 201. In particular, the deep learning unit 205 feeds the input data 201 into the trained deep learning model 203 to generate the prediction. As stated above, the deep learning model 203 may be at least one of a multilayer perceptron (MLP) model, a convolutional neural network (CNN) model, a recursive neural network (RNN) model, a recurrent neural network (RNN) model, or a long short-term memory (LSTM) model, For example, when the deep learning unit 205 performs predictions for sentiment analysis and finally predicts a result (i.e., sentiment), the accuracy of the predicted result depends upon the ability of the deep learning model 203. The prediction is generally executed in accordance with the activation of neurons in each layer of the neural network. The prediction is delivered in binary form i.e. 0 or 1, wherein 1 indicates positive sentiment and 0 indicates negative sentiment. The deep learning unit 205 is connected to the activation pattern extraction unit 207 for transmitting the predicted result and the activation patterns of the neuron corresponding to the predicted result.

The activation pattern extraction unit 207 is connected between the deep learning unit 205 and the prediction validation unit 208. The activation pattern extraction unit 207 extracts the neuron activation pattern as well as predicted results from the deep learning unit 205. The unit 207 analyzes the activation of neurons in various layers (e.g., in LSTM layer and the dense layer), and forms activation vectors for various layers based on the activation patterns of neurons in the corresponding layers. The unit 207 transmits the predicted result received from the deep learning unit 205 in conjunction with the activation vectors to the prediction validation unit 208.

The prediction validation unit 208 is connected to the data repository 202, the activation pattern extraction unit 207 and the controlling unit 209. The prediction validation unit 208 receives the predicted result and the activation vectors from the activation pattern extraction unit 207 and fetches the prediction validation model 203 stored in the data repository 202. The prediction validation unit 208 then feeds the activation vectors into the trained prediction validation model 205 so as to determine correctness of the prediction made by the deep learning model 203. In some embodiments, the prediction validation unit 208 logically analyzes the activation vectors of the trained prediction validation model 204 with the activation vector received from the activation pattern extraction unit 207. Based on this comparison, the prediction validation unit 208 estimates probability of predicted result to be correct/incorrect. In other words, the prediction validation unit 208 determines the chances of prediction made by the deep learning unit 207 being correct or incorrect. The prediction validation unit 208, basically, calculates the probability of occurrence of incorrect prediction in percentage and based on that generates a verdict for the prediction. For example, the prediction is a positive result, however the verdict of prediction may be “The prediction may be about 70% incorrect”. The prediction validation unit 208 further transmits the prediction and verdict of prediction to the controlling unit 209.

The controlling unit 209 connects the prediction validation unit 205 to the user interface 210. The unit 209 receives the prediction and the verdict on the prediction, then combine both of them for further processing. The user interface 210 is provided in the system 200 to display the predicted result along with the verdict on the prediction.

It should be noted that the prediction validation device 107, 206 may be implemented in programmable hardware devices such as programmable gate arrays, programmable array logic, programmable logic devices, or the like. Alternatively, the prediction validation device 107, 206 may be implemented in software for execution by various types of processors. An identified engine/unit of executable code may, for instance, include one or more physical or logical blocks of computer instructions which may, for instance, be organized as an object, module, procedure, function, or other construct. Nevertheless, the executables of an identified engine/unit need not be physically located together, but may include disparate instructions stored in different locations which, when joined logically together, comprise the identified engine/unit and achieve the stated purpose of the identified engine/unit. Indeed, an engine or a unit of executable code may be a single instruction, or many instructions, and may even be distributed over several different code segments, among different applications, and across several memory devices.

As will be appreciated by one skilled in the art, a variety of processes may be employed for creating deep learning model and prediction validation model, and for employing the prediction validation model to determine correctness of predictions performed by the deep learning model. For example, the exemplary system 100 and the associated prediction validation device 107 may create deep learning model and prediction validation model, and the exemplary system 200 and the associated prediction validation device 206 may determine correctness of predictions performed by the deep learning model by the processes discussed herein. In particular, as will be appreciated by those of ordinary skill in the art, control logic and/or automated routines for performing the techniques and steps described herein may be implemented by the system 100, 200 and the associated prediction validation device 107, 206, either by hardware, software, or combinations of hardware and software. For example, suitable code may be accessed and executed by the one or more processors on the system 100, 200 to perform some or all of the techniques described herein. Similarly, application specific integrated circuits (ASICs) configured to perform some or all of the processes described herein may be included in the one or more processors on the system 100, 200.

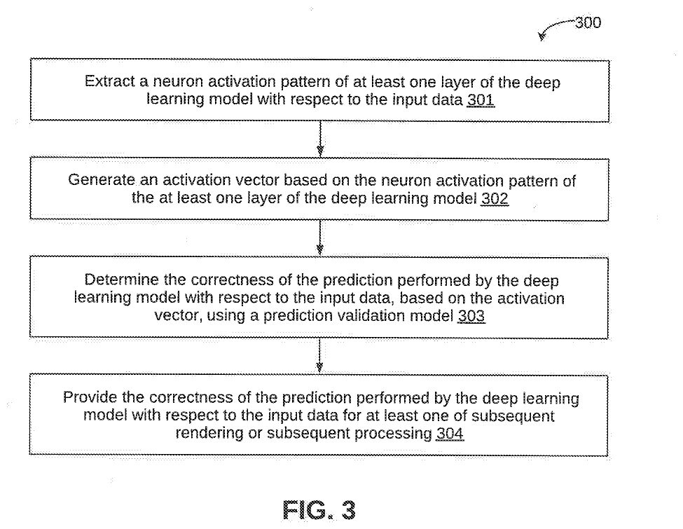

For example, referring now to FIG. 3, exemplary control logic 300 for determining correctness of predictions performed by deep learning model is depicted via a flowchart, in accordance with some embodiments of the present disclosure. It should be noted that, the correctness of the prediction is determined with the help of prediction validation device 206 of the system 200.

As illustrated in the flowchart, at step 301, a neuron activation pattern is extracted from the deep learning model 203, by the activation pattern extraction unit 207 provided in the prediction validation device 206. Further, the neuron activation pattern may be extracted from at least one layer of the deep learning model 203 with respect to input data 201. In this step, LRP mechanism is applied for extracting the layer wise activation patterns of neurons. In some embodiments, the at least one layer may include at least one of a dense layer and a long short-term memory (LSTM) layer of the deep learning model 203.

At step 302, an activation vector is generated by the pattern extraction unit 207 of prediction validation device 206. The extracted neuron activation pattern of the at least one layer is utilized for generating the activation vector. In some embodiments, multiple activation vectors may be generated corresponding to multiple layers of the deep learning model 203.

At step 303, the correctness of the prediction made by the deep learning model 203 with respect to the input data 201 is determined. For the determination of correctness, the prediction validation unit 208 of prediction validation device 206 gets activated. The prediction validation unit 208 determines the probability of correct/incorrect prediction with respect to the input data 201, based on the activation vector generated by pattern extraction unit 207, using a prediction validation model 204, It should be noted that the prediction validation model 204 is a machine learning model that is generated and trained by the system 100 using multiple training activation vectors derived from correctly predicted test dataset and incorrectly predicted test dataset of the deep learning model 203.

At step 304, the correctness of the prediction performed by the deep learning model 203 with respect to the input data 201 is provided for at least one of subsequent rendering or subsequent processing. For example, in some embodiments, the correctness of the prediction performed by the deep learning model 203 with respect to the input data 201 may be provided to a user via a user interface. Alternatively, in some embodiments, the correctness of the prediction performed by the deep learning model 203 with respect to the input data 201 may be provided to another system (e.g., decision making system of autonomous vehicle, diagnostic device, etc.) for subsequent processing (e.g., decision making).

In some embodiments, the control logic 300 may include additional steps (not shown) of creating the deep learning model 203 and the prediction validation model 204. For example, the deep learning model 203 may be generated and trained using annotated training data from training dataset. Further, the deep learning model 203 may be tested using test data from test dataset. The test dataset may then be segregated into the correctly predicted test dataset and the incorrectly predicted test dataset. Further, neuron activation patterns of the at least one layer of the deep learning model 203 may be extracted with respect to the correctly predicted test dataset and the incorrectly predicted test dataset. The extracted neuron activation patterns may then be employed to generate the training activation vectors. Moreover, the prediction validation model 204 may be generated and trained using the training activation vectors.

As discussed above, the deep learning model 203 may include at least one of a multilayer perceptron (MLP) model, a convolutional neural network (CNN) model, a recursive neural network (RNN) model, a recurrent neural network (RNN) model, or a long short-term memory (LSTM) model. Similarly, as discussed above, the prediction validation model 204 is a machine learning model, which may include one of a support vector machine (SVM) model, a random forest model, an extreme gradient boosting model, and an artificial neural network (ANN) model.

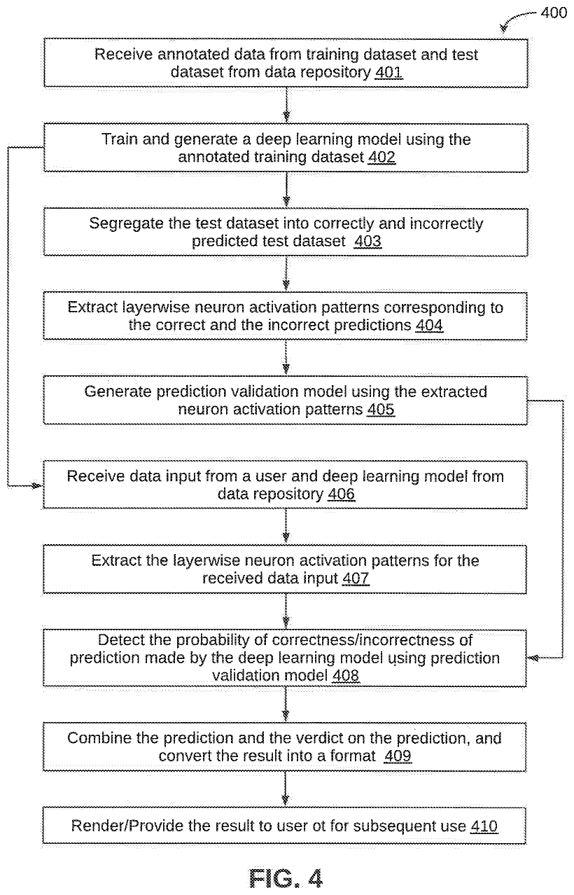

Referring now to FIG. 4, exemplary control logic 400 for determining correctness of predictions performed by a deep learning model is depicted in greater detail via a flowchart, in accordance with some embodiments of the present disclosure. It should be noted that, the non-operational phase of the control logic 400 may be implemented with the help of the prediction validation device 107 of the system 100, while the operational phase of the control logic 400 may be implemented with the help of the prediction validation device 206 of the system 200. As will be appreciated, steps 401-405 is a non-operational phase in which the deep learning model 203 as well as the prediction validation model 204 is created. Further, as will be appreciated, steps 406-410 is an operational phase in which correctness of the predictions performed by the deep learning model 203 is determined by the prediction validation model 204.

At step 401, the annotated data 101 from training dataset and test dataset is received by the deep learning unit 102. The received annotated data 101 is processed for training and generating as well as for testing the deep learning model 105. For example, in a use case of sentiment analysis, after receiving the annotated data or labelled data 101, the sentiment tagged sentences are cleaned, punctuations and irrelevant words are removed, and the sentences are tokenized. The annotated data 101 is further separated into the training data and the testing data. The training data is used to train and generate the deep learning model, while the testing data is used to test the trained deep learning model.

By way of an example, consider a situation, wherein 50,000 movie reviews are used as the annotated data 101 and are provided to the deep learning unit 102 for generating, training, and testing the deep learning model 105 for a sentiment analysis application. Herein, the sentiment of the reviews is preferably binary, i.e., when the movie rating is less than five, then the result is a sentiment score of “0” (i.e., reflecting negative sentiment) and when the rating is greater than or equal to seven, then the result is a sentiment score of “1” (i.e., reflecting positive sentiment). Furthermore, no single movie has more than 30 reviews. By way of another example, 25,000 labelled or annotated reviews in the training dataset does not include the same movies as the 25,000 labelled or annotated reviews in the test dataset. The training dataset of 25,000 reviews and test dataset of 25,000 reviews are equally divided between positive reviews and negative reviews.

At step 402, the deep learning model 105 is trained and generated by the deep learning unit 102 after receiving the annotated data 101 of the training dataset. In an embodiment, a Recurrent Neural Network (RNN) is used to predict the sentiment of sentence by training on the annotated data 101 in the training dataset. Here, one of the objectives includes generation of an accurate binary classifier, for a number of applications, and on a standard data (i.e., movie review dataset). Thus, a binary classifier is generated for the sentiment analysis that provides two polarities including positive and negative polarity. The binary classifier is then tested over the test dataset, and any incorrect predictions is used for estimating the probability of incorrect prediction.

By way of an example, the movie reviews dataset is considered as the binary classification dataset for the generation of sentiments. As discussed above, it includes 25,000 test samples, thus a sample score is provided to select incorrect predictions and analyze the neuron activation patterns for the same. For the classification, a stacked bidirectional LSTM based architecture is utilized. This will enable to obtain sufficient amount of data for training the prediction validation model.

At step 403, segregation of test dataset into correctly predicted dataset and incorrectly predicted dataset is performed by the deep learning unit 102. The correct as well as incorrect predictions generated by the deep learning model 203 (e.g., sentiment analyzer) are sampled separately in order to recognize the patterns that appear for predictions, especially for incorrect predictions. Further, the deep learning unit 102 sends the correct predictions and the incorrect predictions to the activation pattern extraction unit 103.

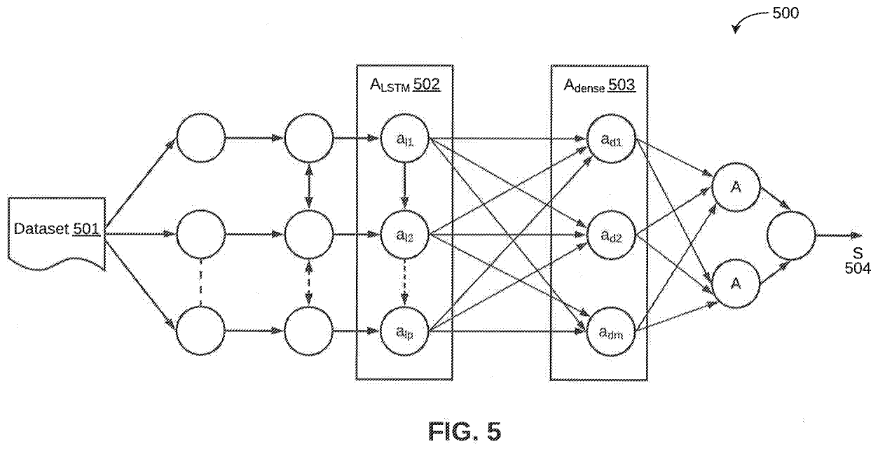

At step 404, layer-wise extraction of neuron activation pattern is executed by the activation pattern extraction unit 103 corresponding to the correct and the incorrect predictions. The neuron activation patterns in each layer of the deep learning model 203 is extracted for understanding the behavior of the deep learning model 203. In some embodiments, the neuron activation patterns in the fully connected (i.e., dense) layer and the LSTM layer is of the deep learning model 203 is extracted as significant patterns are observed in these two layers. These layers will be described in greater detail in conjunction with FIG. 5. A classifier is generated for obtaining a verdict over the sentiment prediction based on the layer-wise neuron activations. In some embodiments, layer-wise neuron relevance patterns corresponding to the correct and the incorrect predictions may be extracted in place of or in addition to the layer-wise neuron activation patterns for understanding the behavior of the deep learning model 203. In such embodiments, the neuron relevance patterns may be extracted for one or more layers of the deep learning model 203. For example, in some embodiments, the neuron relevance patterns may be extracted for only fully connected (i.e., dense) layer as significant patterns are observed in this layer.

At step 405, a prediction validation model 106 is created by the prediction validation unit 104 based on the extracted layer-wise neuron activation patterns for the correct and the incorrect predictions. The prediction validation unit 104 generates layer-wise training activation vectors corresponding to the correct/incorrect predictions and based on the layer-wise neuron activation patterns for the correct/incorrect predictions. The prediction validation unit 104 then trains and generates a prediction validation model 106 based on the layer-wise training activation vectors. In some embodiments, the prediction validation model 106 may be created based on the extracted layer-wise neuron relevance patterns for the correct and the incorrect predictions in place of or n addition to the layer-wise neuron activation patterns. In such embodiments, layer-wise training relevance vectors corresponding to the correct/incorrect predictions may be generated. The layer-wise training relevance vectors may be then used to trains and generates the prediction validation model 106. Further, the prediction validation unit 104 sends the generated prediction validation model 106 to the data repository 108. The generated prediction validation model 106 is used to determine the correctness of predictions made by the deep learning model 203 in operational phase (i.e., in real-time).

At step 406, a data input 201 from a user and the deep learning model 203 from the data repository 202 are received by the deep learning unit 205. Once the data input 201 is received, the deep learning unit 205 performs prediction by employing the deep learning model 203. For example, the sentiment analyzer deep learning model 203 employed by the deep learning unit 205 analyzes the sentiment or polarity of the input data 201. Further, the deep learning unit 205 sends the prediction to the activation pattern extraction unit 207.

At step 407, the layer-wise neuron activation patterns are extracted from the deep learning model 203 for the received input data 201 by using the activation pattern extraction unit 207. In some embodiments, the activation pattern extraction unit 207 extracts the activations of the neurons from the LSTM layer and the dense layer and generates corresponding activation vectors. Again, in some embodiments, the layer-wise neuron relevance patterns may be extracted from the deep learning model 203 for the received input data 201 in place of or in addition to the layer-wise neuron activation patterns.

At step 408, the probability of correctness/incorrectness of the prediction is determined with the help of prediction validation unit 208. In this step, the trained prediction validation model 204 is extracted from the data repository 202 and employed to determine the probability of correct/incorrect predictions made by the deep learning model 203. The determination of the probability (i.e., verdict on the prediction) is based on the activation vectors derived from the layer-wise neuron activation patterns received from the activation pattern extraction unit 207. In some embodiments, the activation vectors are logically analyzed with respect to the activation vectors from the trained prediction validation model 204 to detect any discrepancies. In some embodiments, the verdict on the prediction is based on the relevance vectors, derived from the layer-wise neuron relevance patterns, in place of or in addition to activation vectors.

At step 409, the prediction received from the deep learning unit 205 and the verdict on the prediction received from the prediction validation unit 208 are combined, and the result is converted into a user understandable format, and forwarded to the user. The estimation of incorrectness is a probability that the prediction made by the deep learning model 203 might be incorrect, based on the patterns found in the neuron activations and/or neuron relevance of the certain layers of the neural network of the deep learning model 203.

At step 410, the prediction of the deep learning model 203 with respect to the input data 201 along with the verdict of the prediction (i.e., probability of the correctness/incorrectness of the prediction) are provided to the user on the user interface 210. In some embodiments, the prediction and the verdict with respect to the input data 201 may be provided to another system for subsequent processing (e.g., decision making by autonomous vehicle).

Referring now to FIG. 5, a neural network based deep learning model 500 with activation vectors in the LSTM and the dense layers is illustrated, in accordance with some embodiments of the present disclosure. The layers of the neural network based deep learning model 500 include a text embedding layer, a bi-directional long short-term memory (Bi-LSTM) layer, a long short-term memory (LSTM) layer, a fully connected/dense layer, and a SoftMax layer. In the illustrated embodiment, the dense layer and the LSTM layer have been considered for neuron activation pattern extraction. The neuron activations for the LSTM layer are represented by aₗ₁, a₂ₗ, . . . , aₗₚ, and for the dense layer are represented by a_{d1}, a_{d2}, . . . , adₘ.

By way of an example, for a first layer (e.g., dense layer), the activation vector ‘A₁’ (e.g., A_{dense} 503) is given by equation (1) below:

A₁=[a₁₁, a₁₂, . . . , a₁ₘ] (1)

Similarly, the activation vector ‘An’ (e.g., AL_{STM} 502) for nth layer (e.g., LSTM layer) is given by equation (2) below:

Aₙ=[aₙ₁, aₙ₂, . . . , aₙₚ] (2)

where, “m” and “p” are the number of neurons present in the 1st and nth layers, respectively. In other words, the number of neurons may vary from layer to layer.

By way of further example, the verdict is represented as a function “V” over all the activation vectors from first to nth layer, and is given by equation (3) below:

V=v(A1, A2, . . . , An) (3)

where, ‘v’ represents a squashing function. When V=0 then the sentiment prediction is incorrect, and when V=1 then the sentiment prediction is correct.

The sentiment prediction of the neural network based deep learning model 500 is symbolized by ‘S’ 504. The estimated probability (‘P’) by the prediction validation model 204 for sentiment classification is given by equation (4) below:

P(S_{incorrect})=p(V=0|S) (4)

In some embodiments, the estimation of P (S_{incorrect}) is performed by employing extreme gradient boosting (XGB) and support vector machine (SVM) (with Gaussian kernel). Additionally, in some embodiments, the patterns extraction is not executed substantially from all the layers of the neural network based deep learning model 500. As discussed above, in some embodiments, the LSTM layer and the dense layer provide significant insights into the correctness of the sentiment prediction ‘S’ 504. The verdicts from the XGB and SVM classifiers may be represented by equation (5) and equation (6) below:

V_{XGB}=vXGB(A_{LSTM}, A_{dense}) (5)

V_{SVM}=vSVM(A_{LSTM}, A_{dense}) (6)

where, A_{LSTM} 502 and A_{dense} 503 are the activation vectors for the LSTM layer and the dense layer, respectively.

Finally, the probability estimate (‘P’) is determined as per the equation (7) below:

P(S_{incorrect})=θ1 p(VXGB=0|S)+θ2 p(VSVM=0|S) (7)

where ‘θ₁’ and ‘θ₂’ are statistically determined parameters.

By way of an example, a deep learning model with about 80% accuracy from among 25000 test data samples is finalized as trained deep learning model 203. In other words, 5000 (20% Of 25000) incorrect predictions and 20000 correct predictions are made by the deep learning model 203. Further, the number of samples that are sampled from correct prediction samples is about equal to the number of sampled from incorrect prediction samples (i.e., 5000). Therefore, a total of 10000 samples are provided for training the prediction validation model (i.e., classifier for estimation the probability of incorrectness for the deep learning model). The layer-wise activation patterns of neurons are extracted for the 10000 samples from the LSTM and dense layers. Thus, a 4-fold cross-validation was concluded on this dataset. The resultant prediction validation model 204 from the 10000 samples is used to estimate the degree of incorrectness of the prediction made by the deep learning model 203. Once trained, the prediction validation model 204 can be used to obtain the incorrectness estimate for a new test data sample.

For example, a new input text may be as follows:

“OK, what did I just see? This zombie movie is funny. And I mean stupidly funny. I heard this movie is inspired from a popular game of the same name. Well, I should appreciate the effort to make a movie out of the game however that is about it. Really dudes, the tribute was a thumbs down! The performances are laughable, the zombie makeup is comical and the story comes out unconvincing.”

In the above example, the prediction made by the deep learning model 203 and the verdict given by the prediction validation model 204 may be as follows:

Prediction: The sentiment of the input text is positive.
Verdict: There is a 76.4% chance that the prediction is incorrect

Similarly, in another use case, a block of text may be taken from social media so as to provide the opinion on the same as well identify potential misclassifications. Thus, the techniques may be employed to accurately identify the incorrect predictions that might have been made by a deep learning model.

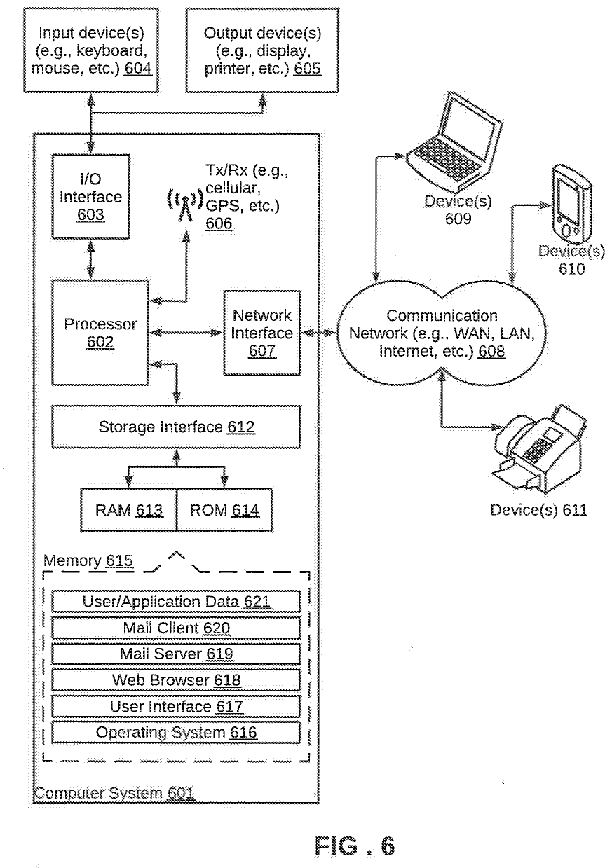

The disclosed methods and systems may be implemented on a conventional or a general-purpose computer system, such as a personal computer (PC) or server computer. Referring now to FIG. 6, a block diagram of an exemplary computer system 601 for implementing embodiments consistent with the present disclosure is illustrated. Variations of computer system 601 may be used for implementing system 100 or the associated prediction validation device 107 for creating deep learning model and prediction validation model. Further, variations of computer system 601 may be used for implementing system 200 or the associated prediction validation device 206 for determining correctness of predictions performed by the deep learning model. Computer system 601 may include a central processing unit (“CPU” or “processor”) 602. Processor 602 may include at least one data processor for executing program components for executing user-generated or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD® ATHLON®, DURON® OR OPTERON®, ARM's application, embedded or secure processors, IBM® POWERPC®, INTEL® CORE® processor, ITANIUM® processor, XEON® processor, CELERON® processor or other line of processors, etc. The processor 602 may be implemented using mainframe, distributed processor, multi-core, parallel, grid, or other architectures, Some embodiments may utilize embedded technologies like application-specific integrated circuits (ASICs), digital signal processors (DSPs), Field Programmable Gate Arrays (FPGAs), etc,

Processor 602 may be disposed in communication with one or more input/output (I/O) devices via I/O interface 603. The I/O interface 603 may employ communication protocols/methods such as, without limitation, audio, analog, digital, monoaural, RCA, stereo, IEEE-1394, near field communication (NFC), FireWire, Camera Link®, GigE, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 603, the computer system 601 may communicate with one or more I/O devices. For example, the input device 604 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 605 may be a printer, fax machine, video display (e.g., cathode ray tube (CRT), liquid crystal display (LCD), light-emitting diode (LED), plasma, or the like), audio speaker, etc. In some embodiments, a transceiver 606 may be disposed in connection with the processor 602. The transceiver may facilitate various types of wireless transmission or reception. For example, the transceiver may include an antenna operatively connected to a transceiver chip (e.g., TEXAS INSTRUMENTS® WILINK WL1286®, BROADCOM® BCM45501UB8®, INFINEON TECHNOLOGIES® X-GOLD 618-PMB9800® transceiver, or the like), providing IEEE 802.11a/b/g/n, Bluetooth, FM, global positioning system (GPS), 2G/3G HSDPA/HSUPA communications, etc.

In some embodiments, the processor 602 may be disposed in communication with a communication network 608 via a network interface 607. The network interface 607 may communicate with the communication network 608. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 608 may include, without limitation, a direct interconnection, local area network (LAN), wide area network (WAN), wireless network (e.g., using Wireless Application Protocol), the Internet, etc. Using the network interface 607 and the communication network 608, the computer system 601 may communicate with devices 609, 610, and 611. These devices may include, without limitation, personal computer(s), server(s), fax machines, printers, scanners, various mobile devices such as cellular telephones, smartphones (e.g., APPLE® IPHONE®, BLACKBERRY® smartphone, ANDROID® based phones, etc.), tablet computers, eBook readers (AMAZON® KINDLE®, NOOK® etc.), laptop computers, notebooks, gaming consoles (MICROSOFT® XBOX®, NINTENDO® DS®, SONY® PLAYSTATION®, etc.), or the like. In some embodiments, the computer system 601 may itself embody one or more of these devices.

In some embodiments, the processor 602 may be disposed in communication with one or more memory devices (e.g., RAM 613, ROM 614, etc.) via a storage interface 612. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), STD Bus, RS-232, RS-422, RS-485, I2C, SPI, Microwire, 1-Wire, IEEE 1284, Intel® QuickPathInterconnect, InfiniBand, PCle, etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 616, user interface application 617, web browser 618, mail server 619, mail client 620, user/application data 621 (e.g., any data variables or data records discussed in this disclosure), etc. The operating system 616 may facilitate resource management and operation of the computer system 601. Examples of operating systems include, without limitation, APPLE® MACINTOSH® OS X, UNIX, Unix-like system distributions (e.g., Berkeley Software Distribution (BSD), FreeBSD, NetBSD, OpenBSD, etc.), Linux distributions (e.g., RED HAT®, UBUNTU®, KUBUNTU®, etc.), IBM® OS/2, MICROSOFT® WINDOWS® (XP®, Vista®/7/8, etc.), APPLE® IOS®, GOOGLE® ANDROID®, BLACKBERRY® OS, or the like. User interface 617 may facilitate display, execution, interaction, manipulation, or operation of program components through textual or graphical facilities. For example, user interfaces may provide computer interaction interface elements on a display system operatively connected to the computer system 601, such as cursors, icons, check boxes, menus, scrollers, windows, widgets, etc. Graphical user interfaces (GUIs) may be employed, including, without limitation, APPLE® MACINTOSH® operating systems' AQUA® platform, IBM® OS/2®, MICROSOFT® WINDOWS® (e.g., AERO®, METRO®, etc.), UNIX X-WINDOWS, web interface libraries (e.g., ACTIVEX®, JAVA®, JAVASCRIPT®, AJAX®, HTML, ADOBE® FLASH®, etc.), or the like.

In some embodiments, the computer system 601 may implement a web browser 618 stored program component. The web browser may be a hypertext viewing application, such as MICROSOFT® INTERNET EXPLORER®, GOOGLE® CHROME®, MOZILLA® FIREFOX®, APPLE® SAFARI®, etc. Secure web browsing may be provided using HTTPS (secure hypertext transport protocol), secure sockets layer (SSL), Transport Layer Security (TLS), etc. Web browsers may utilize facilities such as AJAX®, DHTML, ADOBE® FLASH®, JAVASCRIPT®, JAVA®, application programming interfaces (APIs), etc. In some embodiments, the computer system 601 may implement a mail server 619 stored program component. The mail server may be an Internet mail server such as MICROSOFT®' EXCHANGE®, or the like. The mail server may utilize facilities such as ASP, ActiveX, ANSI C++/C#, MICROSOFT .NET® CGI scripts, JAVA®, JAVASCRIPT®, PERL®, PHP®, PYTHON®, WebObjects, etc. The mail server may utilize communication protocols such as internet message access protocol (IMAP), messaging application programming interface (MAPI), MICROSOFT® EXCHANGE®, post office protocol (POP), simple mail transfer protocol (SMTP), or the like. In some embodiments, the computer system 601 may implement a mail client 620 stored program component. The mail client may be a mail viewing application, such as APPLE MAIL®, MICROSOFT ENTOURAGE®. MICROSOFT OUTLOOK®, MOZILLA THUNDERBIRD®, etc.

In some embodiments, computer system 601 may store user/application data 621, such as the data, variables, records, etc. (e.g., training dataset, test dataset, deep learning model, correctly predicted test dataset, incorrectly predicted test dataset, neuron activation patterns data, activation vectors data, prediction validation model, input data, prediction data, verdict data, and so forth) as described in this disclosure. Such databases may be implemented as fault-tolerant, relational, scalable, secure databases such as ORACLE® OR SYBASE®. Alternatively, such databases may be implemented using standardized data structures, such as an array, hash, linked list, struct, structured text file (e.g., XML), table, or as object-oriented databases (e.g., using OBJECTSTORE®, POET®, ZOPE®, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above are not routine, or conventional, or well understood in the art. The techniques discussed above provide for a prediction validation model to determine correctness of predictions made by a deep learning model, thereby increasing trust in the predictions made by the deep learning model. In particular, the prediction validation model determines a probability of incorrectness for a prediction (i.e., an error in the prediction) made by the deep learning model based on an analysis of layer-wise activation patterns in the deep learning model. The techniques analyze one or more layers of the deep learning model and identify patterns in neuron activations in those layers so as to detect correct and incorrect predictions. Thus, the techniques described in the embodiments discussed above provide for an identification of an incorrect prediction made by the deep learning model, an identification of a degree of confidence in the prediction along with a reason, and/or an identification of significant patterns that emerge in certain layers for both incorrect predictions and correct predictions.

In some embodiments, the techniques may employ analysis of neuron relevance patterns in place of neuron activation patterns without departing from the spirit and scope of the disclosed embodiments. Further, the techniques described above may be employed in any kind of deep neural network (DNN) such as recurrent neural network (RNN), convolutional neural network (CNN), or the like. Moreover, the techniques may be easily deployed in any cloud-based servers for access and use as an ‘application as a service’ by any computing device including mobile device. For example, the prediction validation device 104, 208 may be implemented on a cloud-based server and used for determining correctness of predictions made by various deep learning model based mobile device applications.

The specification has described method and system for determining correctness of a prediction performed by a deep learning model. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of determining a correctness of a prediction performed by a deep learning model with respect to input data, the method comprising:
extracting, by a prediction validation device, a neuron activation pattern of at least one layer of the deep learning model with respect to the input data;
generating, by the prediction validation device, an activation vector based on the neuron activation pattern of the at least one layer of the deep learning model;
determining, by the prediction validation device, the correctness of the prediction performed by the deep learning model with respect to the input data using a prediction validation model and based on the activation vector, wherein the prediction validation model is a machine learning model that has been generated and trained using a plurality of training activation vectors derived from correctly predicted test dataset and incorrectly predicted test dataset of the deep learning model; and
providing, by the prediction validation device, the correctness of the prediction performed by the deep learning model with respect to the input data for at least one of subsequent rendering or subsequent processing.

2. The method of claim 1, wherein the at least one layer comprises at least one of a dense layer and a long short-term memory (LSTM) layer of the deep learning model.

3. The method of claim 1, further comprising:
generating and training the deep learning model using annotated training data from training dataset; and
testing the deep learning model using test data from test dataset.

4. The method of claim 3, further comprising:
segregating the test dataset into the correctly predicted test dataset and the incorrectly predicted test dataset;
extracting a plurality of neuron activation patterns of the at least one layer of the deep learning model with respect to the correctly predicted test dataset and the incorrectly predicted test dataset; and
generating the plurality of training activation vectors based on the plurality of neuron activation patterns of the at least one layer of the deep learning model.

5. The method of claim 1, further comprising generating and training the prediction validation model using the plurality of training activation vectors.

6. The method of claim 1, wherein the machine learning model comprises one of a support vector machine (SVM) model, a random forest model, an extreme gradient boosting model, and an artificial neural network (ANN) model.

7. The method of claim 1, wherein the deep learning model comprises at least one of a multilayer perceptron (MLP) model, a convolutional neural network (CNN) model, a recursive neural network (RNN) model, a recurrent neural network (RNN) model, or a long short-term memory (LSTM) model.

8. A system for determining a correctness of a prediction performed by a deep learning model with respect to input data, the system comprising:
a processor and a memory communicatively coupled to the processor, wherein the memory stores processor-executable instructions, which, on execution, causes the processor to:
extract a neuron activation pattern of at least one layer of the deep learning model with respect to the input data;
generate an activation vector based on the neuron activation pattern of the at least one layer of the deep learning model;
determine the correctness of the prediction performed by the deep learning model with respect to the input data using a prediction validation model and based on the activation vector, wherein the prediction validation model is a machine learning model that has been generated and trained using a plurality of training activation vectors derived from correctly predicted test dataset and incorrectly predicted test dataset of the deep learning model; and
provide the correctness of the prediction performed by the deep learning model with respect to the input data for at least one of subsequent rendering or subsequent processing.

9. The system of claim 8, wherein at least one layer comprises at least one of a dense layer and a long short-term memory (LSTM) layer of the deep learning model.

10. The system of claim 8, wherein the processor-executable instructions further cause the processor to:
generate and train the deep learning model using annotated training data from training dataset; and
test the deep learning model using test data from test dataset.

11. The system of claim 10, wherein the processor-executable instructions further cause the processor to:
segregate the test dataset into the correctly predicted test dataset and the incorrectly predicted test dataset;
extract a plurality of neuron activation patterns of the at least one layer of the deep learning model with respect to the correctly predicted test dataset and the incorrectly predicted test dataset; and
generate the plurality of training activation vectors based on the plurality of neuron activation patterns of the at least one layer of the deep learning model.

12. The system of claim 8, wherein the processor-executable instructions further cause the processor to generate and train the prediction validation model using the plurality of training activation vectors.

13. The system of claim 8, wherein the machine learning model comprises one of a support vector machine (SVM) model, a random forest model, an extreme gradient boosting model, and an artificial neural network (ANN) model.

14. The system of claim 8, wherein the deep learning model comprises at least one of a multilayer perceptron (MLP) model, a convolutional neural network (CNN) model, a recursive neural network (RNN) model, a recurrent neural network (RNN) model, or a long short-term memory (LSTM) model.

15. A non-transitory computer-readable medium storing computer-executable instructions for:
extracting a neuron activation pattern of at least one layer of the deep learning model with respect to the input data;
generating an activation vector based on the neuron activation pattern of the at least one layer of the deep learning model;
determining the correctness of the prediction performed by the deep learning model with respect to the input data using a prediction validation model and based on the activation vector, wherein the prediction validation model is a machine learning model that has been generated and trained using a plurality of training activation vectors derived from correctly predicted test dataset and incorrectly predicted test dataset of the deep learning model; and
providing, the correctness of the prediction performed by the deep learning model with respect to the input data for at least one of subsequent rendering or subsequent processing.
